(19) United States
(12) Patent Application Publication
(10) Pub. No.: US 2009/0219580 A1
(43) Pub. Date: Sep. 3, 2009

(54) SCANNING SYSTEM WITH REAL-TIME DISPLAY UNIT

(76) Inventors: David J. Cornell, Scottsville, NY (US); Joseph A. Manico, Rochester, NY (US)

Correspondence Address: David A. Novais;Patent Legal Staff, Eastman Kodak Company, 343 State Street, Rochester, NY, 14650-2201, US

(21) Appl. No.: 12/039,075

(22) Filed: Feb. 28, 2008

(51) Int. Cl. H04N 1/04; H04N 1/00

(52) U.S. Cl. 358/474; 358/494; 358/425

(57) ABSTRACT

A scanning system with display system including a scanning module mounted in a body, such that the scanning module scans in a capture zone to capture an archival image of said capture zone. One or more image capture modules mounted in the body in fixed relation to the capture zone being operative to capture one or more real time images in the capture zone for display

### FIELD OF THE INVENTION

The invention relates to a printer having a scanner and more particularly relates to a scanner with one or more image capture modules being operative to include a display system and related method.

### BACKGROUND OF THE INVENTION

Document scanners have become a popular computing accessory both in the home and the office. Essentially, document scanners (or simply “scanners”) come in three distinct varieties: sheet-fed scanners, platen scanners and scanners having a rigid combination of sheet-fed and platen scanning capabilities. With respect to sheet-fed scanners, an image-forming subsystem, such as a camera, typically including a linear imaging sensor and a lens in combination with an illumination source, scans an image by moving a sheet of paper past the sensor, which sits in a stationary position. The documents are fed from a stack and are passed through a paper path disposed at the field of view of the sensor. As each document passes in front of the sensor individual raster lines are imaged by the imaging device and then pieced together to create a 2D image representation of the original document. The imaging device captures the width of the image, line by line, while the document is moved past the sensor.

With respect to platen scanners, a document is placed face down onto a stationary flat transparent surface of the scanner and the image-forming subsystem and illumination source, moves underneath the fixed document to perform the scanning operation. In this case, the imaging device is moved the length of the document while the optics covers the width of the scanned document. The platen scanner requires lifting a lid and placing document sheets face down one at a time. The platen capability is also employed to deal with documents that do not feed from a stack reliably.

Scanners vary in speed, function, and cost and are often used by businesses for scanning large quantities of documents. The demand for scanning at a given installation can be as high as from several hundred (100) to several hundred thousand (100,000) pages per day. Sheet-fed scanners offer greatest productivity by employing an imaging system on both sides of the paper path, imaging both the front and back of each document during the same scanning operation. One type of production scanner attempts to combine the functionality of a sheet-fed scanner with that of a platen scanner. Essentially, such combination production scanners are manufactured as a single unit that combine the platen scanning functions with the sheet moving functions in a single box.

With prior sheet-fed, platen, or combination scanners, the user must select one type in favor of another. For those customers whose primary need is for a sheet-fed scanner but who occasionally need the platen utility, they must purchase a combination device or two separate scanners (one sheet-fed and one platen). Purchasing both types of scanning devices may be cost prohibitive or impossible and, in either case, impractical for applications where portability is desired. For example, a scanning service provider may require the ability to carry the scanner and host computer in order to transport both systems to a remote jobsite. After the job is finished, the scanner and computer must be brought back to the service bureau headquarters or to the next jobsite. One task may require scanning a large number of similar documents, suited to the sheet-fed scanner and not requiring a platen. The next task at the next site may require scanning fragile documents or books, requiring the use of a platen. Thus, portability and the ability to reconfigure and perform multiple scanning functions are critical to people who buy scanners to scan documents as a service.

Typically flat bed scanners are configured as desktop computer peripheral devices and therefore they incorporate various data communication, control and power conversion structures suitable for such use. Some scanners of this type can operate independently from the computer when used as a component for an “all-in-one” device also incorporating a printer and modem to provide copying and taxing capabilities. However, scanners of this type typically do not include portable power supplies and may have memory card slots and displays, but the displays are used for scanner operation, reading the contents of the memory cards, and displaying the post scanned image when not connected to a computer.

Document scanners come in various sizes to accommodate different sizes of “flat art” including images, documents, artwork, and the like. When scanning documents that are larger that the scan aperture, it is known to use “digital stitching algorithms” to combine multiple overlapping sections of an image into a complete seamless digital image. Because many images are recorded on tangible mediums that are stored in photo albums with image bearing mediums adhered to pages with many different techniques using glues, adhesives, and tapes, removal of these image bearing mediums from the photo albums would be labor intensive, time consuming, and could subject fragile, one of a kind, images to potential damage. Since photo albums typically are formed by bound pages it would not be possible to scan these pages with a smaller format scanner with an incorporated print feed mechanism. In addition, when attempting to scan bound albums with a typical flat bed scanner, damage to the binder, binding means, and/or book spine could occur when pressing an opened album against the scan aperture. Finally, transporting a large format document scanner, that is not capable of operating independently from a computer, to an event such as a family holiday celebration in order to copy images from a bound photo album would be difficult if not impractical.

Another problem with such flat bed scanning systems and other known scanning devices for scanning a document having an image recorded thereon is that such systems do not have real-time viewing capability. This is important because in order to use most scanners to their full potential there is a need to interact with the scanner and/or copier in real time, such as when repositioning a document on a scanning surface.

It is desirable to have a scanner system and related methods of scanning that correct these problems. A scanner and/or printer that is actuatable to capture an archival image of the capture zone in real time.

### SUMMARY OF THE INVENTION

The invention is defined by the claims. The invention, in broader aspects, provides a body, a transparent platen mounted to the body to define a capture zone adjoining the platen also including, a scanning module mounted in the body to scan the capture zone and to capture an image of the document in the capture zone in real time.

### BRIEF DESCRIPTION OF THE DRAWINGS

The invention and its objects and advantages will become apparent upon reading the following detailed description and upon reference to the drawings.

FIGS. 1-3 are perspective views of a prior art sheet-fed, platen, and combination scanners.

FIG. 4 is a perspective view of a scanning system with real-time display according to the present invention.

FIG. 5 is a schematic side view, showing details of the internal mechanisms of the scanning system.

FIG. 6 shows a portion of an embodiment of a scanning system.

FIG. 7 is an embodiment of the scanning system.

FIG. 8 shows the embodiment of the scanning system.

FIG. 9 shows the embodiment of the scanning system.

FIG. 10 shows the steps for a method of using the document scanner with display system.

FIG. 11 shows an embodiment of the scanning system.

### DETAILED DESCRIPTION OF THE INVENTION

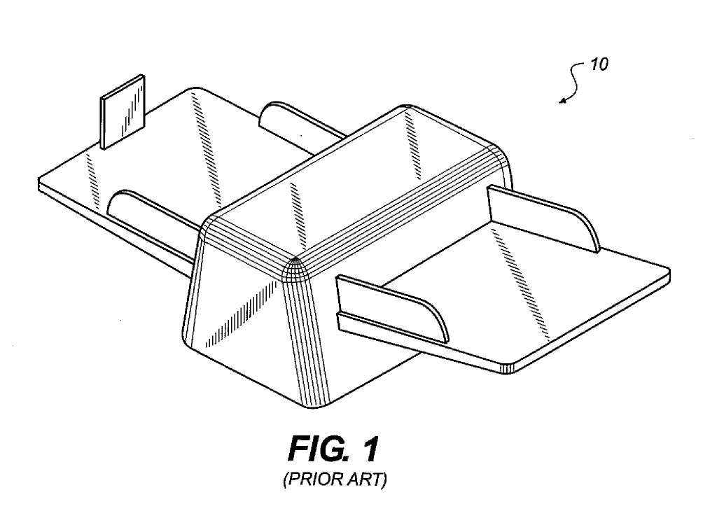

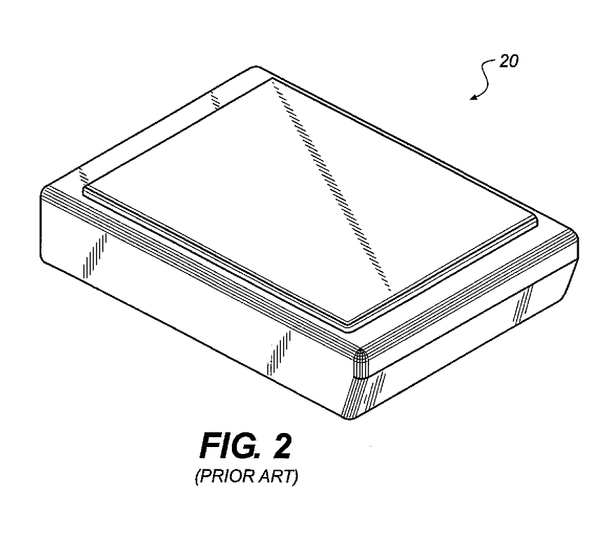

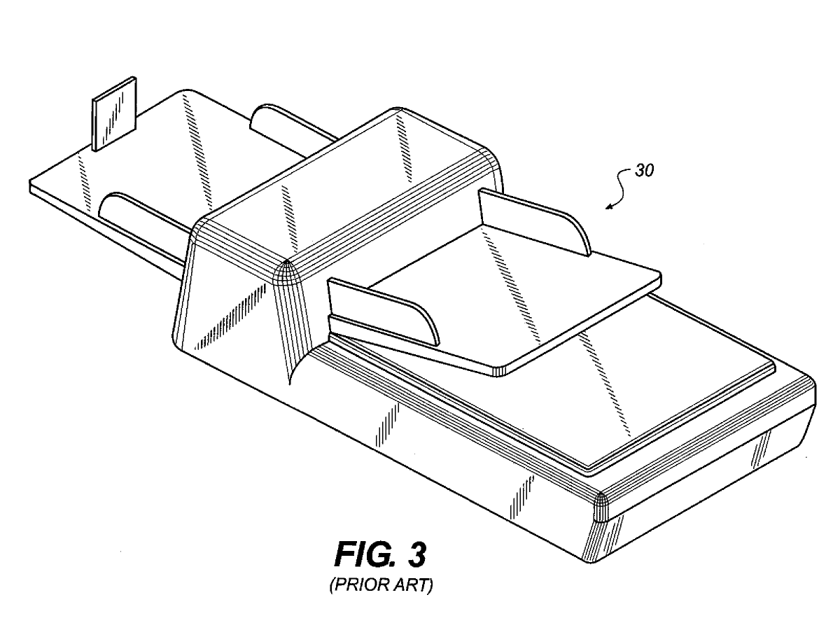

Essentially, document scanners (or simply “scanners”) come in three distinct varieties: sheet-fed scanners 10 as shown in FIG. 1, platen scanners 20 shown in FIG. 2, and scanners 30 having a rigid combination of sheet-fed and platen scanning capabilities shown in FIG. 3. With respect to platen scanners 20, a document is placed face in relation to a platen, often face down onto a stationary flat transparent surface of the scanning unit so that an image-forming subsystem and illumination source can move underneath the fixed document to perform the scanning operation. The platen scanner can require lifting a lid and placing document sheets face down one at a time. The platen capability is also employed to deal with documents that do not feed from a stack reliably.

Scanners vary in speed, function, and cost and are often used by businesses for scanning large quantities of documents. The demand for scanning at a given installation can be as high as from several hundred (100) to several hundred thousand (100,000) pages per day. Sheet-fed scanners offer greatest productivity by employing an imaging system on both sides of the paper path, imaging both the front and back of each document during the same scanning operation. One type of production scanner 30 attempts to combine the functionality of a sheet-fed scanner with that of a platen scanner. Essentially, such combination production scanners are manufactured as a single unit that combine the platen scanning functions with the sheet moving functions in a single box. More recently combination scanners have become popular. Prior art scanners that have preview functions do not actually show you the preview in real time because the scanner first previewed the image which takes a period of time, and then the user viewed the image. This was not real-time viewing.

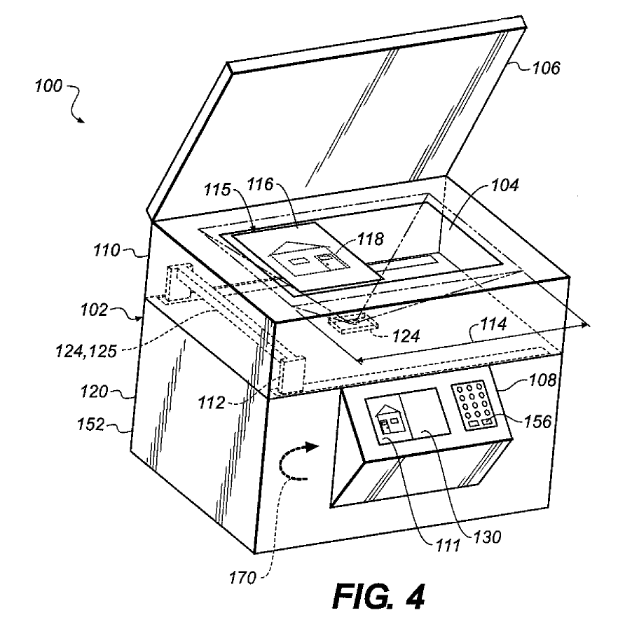

FIG. 4 shows a document scanner with real-time display system 100, hereafter referred to as a real-time document scanner or simply scanning system 100. One skilled in the art wild understand that the display system could be used in conjunction with other similar systems such as copies, fax machines, mobile phone and other devices used in a similar manner. The scanning system 100 includes a body 102, a platen 104 held by the body 102, and an optional lid 106. The scanning system 100 has an image viewing system 108 shown here as mounted on the body. The image viewing system 108 could also be located elsewhere as long as it communicated with the scanner. FIG. 4 also shows a scanning module 110 mounted below the platen.

The scanning module 110 has an image forming subsystem 112, such as a linear imager 125, or an image capture module 124, area camera, CCD or a combination of one or more of each. The image forming subsystem 112 being translatable relative to the platen 104 wherein, in this embodiment, the platen defines a capture zone 114. If an item or items 115, such as a document 116 having an image 118, are scanned and portions of the item are not positioned properly or portions are out of the scanning area then the item(s) can be viewed real time or as a non-archival image 111 and can be repositioned with the scanner system 100 prior to printing by a printing engine 120. The document scanner with real-time display system 100 allows real-time viewing since the area camera is situated to overlap the viewing area. The image-forming subsystem has one or more are array cameras and may use these for imaging as well as the real-time viewing, “preview” function. The array cameras can also be combined with linear imagers that may copy the image to produce archival copies or other similar devices.

### Scanning Unit

The scanning unit 110, also referred to as a scanning module, is located in the upper portion of the body 102, also referred to as a housing or cabinet that can house the upper scanning module 110 and the lower printing engine or module 120. The upper portion of the body 102 includes the platen 104 shown here as a transparent (e.g. glass) plate upon which the item 115, such as a document 116 having the image 118 as shown in FIG. 4, is placed in a face-down position. The glass platen 104 is where documents will be placed in relation to an image capture module 124 having a device as described above, is provided in association with platen 104 for capturing of images on documents.

The lower portion of the body 102 encloses the lower printing engine or module 120, sometimes simply referred to as a printer, that houses the mechanisms necessary to effect printing. It is known that these modules could be arranged in other configurations that are known in the art to cooperate to scan and print an item. In this embodiment, the glass top or platen 104 provides the place where documents to be scanned are placed. The optional lid 106 allows covering of the documents to be scanned, and limits the outside influence of lights, which would interfere with proper scanning of a document as well as helps to hold any item flat against platen 104. The lid 106 is attached by a hinge or in another appropriate manner or may be just a lift able separate part. The scanning system contains the same subsystems plus additional systems for communicating to a host computer, the hardware and firmware for processing and transmitting the images, motion controllers, etc.

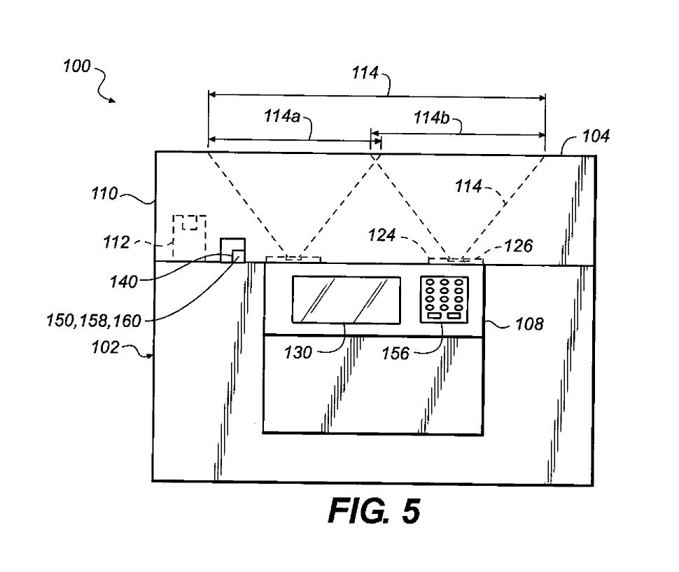

The embodiment shown in FIG. 5 of the present invention shows that the scanning module 110 can include one or more image capture modules 124 or image viewers, shown here as a live, real-time active camera (or cameras), placed in the body of the scanner to output to a display screen 130, such as an LCD screen and shown in FIG. 4 as mounted on the body 102 but which could be connected in a wired or wireless configuration adjacent to or remote from the body. This allows the user access to a live picture of what is in the high-resolution system 100 in what can be a low resolution image as seen in the capture zone 114. The capture zone is defined by the angle of view of the image capture modules 124. This embodiment has two image capture modules 124, each having an angle of view and together forming an angle of view that encompasses the whole platen.

The user has an active/live real-time view of the object on the scanner platform. This view can be low resolution or non-archival in that it is not held in long-term memory and is not intended for long-term use or it can be a high resolution image that is archived thus eliminating a need for a separate linear scanner to capture the archived images that are intended for long-term use in a down stream process. The scanning system 100 can be adapted to engage an interface that can be used to convey images and related data to and/or from any imaging device including any electronic device having images stored therein including, but not limited to cellular phones, personal digital assistants, personal computers, and image players.

FIG. 5 shows a portion of the scanning system 100 including the image-forming subsystem 112, for linear capture of an archival item in addition to the image capture module 124 that is used in this embodiment to capture an image in real time for real time display. One or more light sources 126 respectively, provide the light energy necessary to illuminate images on the document and supply any light that might be needed by the image capture modules 124 Alternatively any required light needed, the light source, could be provided by an internal part of the imaging control module 125, such as a LED. The image-forming subsystem 112 traverses along an axis substantially parallel to axis Y. A translation means is provided within the enclosure and attached to the image-forming subsystem and causing it to move in a direction permitting scanning of documents placed on the glass top. The translation means can include a pulley and belt system adapted to engage the image-forming subsystem for effecting its motion and permitting platen scanning of documents placed on the glass top. A rod or rods within the enclosure can be engaged with the image-forming subsystem and guide its movement for platen scanning.

### Image Capture Device

To obtain images, the one or more image capture modules 124 that utilize the image capture device as shown in FIG. 5, which is typically configured as a charge couple device (CCD) and/or a camera with a light source. The use of a CCD or other device can be paired with appropriate filtration and sensitivity capture red, green, and blue image signals from the image bearing mediums being scanned. These additional features may not be necessary since in most instances only a low-resolution image will be needed since for the non-archival images. Other forms of image sensors can be used such as those that use complimentary metal oxide, and charge injection devices to capture image information. Image information from image scanner is provided to scanner driver having appropriate driving and image processing circuits and systems of the type commonly used to convert image data from image scanner into a digital image. The scanner can, for example, contain a single camera, usually comprised of one or more CCD or CMOS arrays and supporting electronics, and a motor for moving the camera.

### Control Unit

A controller 140 and processor 150, as shown in FIG. 5, is used to control portions of the scanning operation, including parts of the scanning system such as the image capture module 125, which would allow them to be coordinated in such a way that one may be operating at times the other is not as well as for other scanning related options. The controller could let an operator use one or the other or both at the same time. The controller can include a microprocessor, micro-controller, or any other electronic circuit adapted to govern image scanning, processing, storage and sharing processes. The captured digital images may be stored, transmitted and/or manipulated as desired. The captured archival digital images may be sent to a device for writing the information on to a storage medium for example, a CD or computer disk and/or sent to the viewer.

### Printing Engine

FIG. 5 shows the printing engine 120 that applies markings or otherwise forms an image on a receiver medium, such as a document 116 within a printable area with the printable area being constrained as is known in the art by the size of the receiver medium, the type of printing engine used and the type of receiver medium. Preferably, the printable area extends across all of the available space on (receiver medium. The printing engine can record images on receiver medium using a variety of known technologies including conventional four color offset separation printing or other contact printing, silk screening, dry electrophotography such as is used in the NexPress 2100 printer sold by Eastman Kodak Company, Rochester, N.Y., USA, thermal printing technology, drop on demand ink jet technology and continuous inkjet technology. For the purpose of the following discussions, printing engine will be described as being of a type that generates color images. However, this is not necessary and the claimed methods and apparatuses can be practiced with a printing engine that is adapted to form monotone images such as black and white, grayscale or sepia toned images. Medium advance is used to position the receiver medium and/or printing engine relative to each other to facilitate recording of an image on receiver medium

The image viewing system 108 of the scanning system 100 is mounted relative to the body as shown in FIG. 5 including the image forming subsystem 112 in relation to the capture zone 114. The image viewing system 108 can also include a user input system 156 or other device capable of receiving an input from a user and converting this input into a form that can be used by a processor 150. For example, user input system 156 can comprise a touch screen input, a touch pad input, a 4-way switch, a 6-way switch, an 8-way switch, a stylus system, a trackball system, a joystick system, a voice recognition system, a gesture recognition system or other such systems. In the embodiment illustrated in FIG. 5 the user input system 156 includes a keypad or keyboard for receiving input from a user. The display 130 is connected to processor 150 and provides information to a user so that the user can interact with printer 120 and scanning module 110. Various components of user input system 156 and/or display 130 can be located within housing or can be separate therefrom. Where separate, user input system 156 and display 130 can exchange signals with processor 150 by way of wired or wireless signals and connections.

The image viewing system 108 acts as the user interface with human interface features allowing a user to input information in a way that can be detected by controller 140 and the display 130 allowing the scanning module 110 to provide information to the user. Display 130 can include a status indicator such as a visible signal or icon, text messages, or images. In the embodiment shown in FIG. 5, the system can be used to receive signals from controller 140 and to convert these signals into a form that can be used by display 130 to present information to a user. This information includes the real time image of the item, having a camera-viewing angle 115, on the platen 104 during scanning. Also shown on FIG. 5 is the “user input system 156”

The scanning system 100 also can include memory 158. Memory 158 can include conventional memory devices including solid state, magnetic, optical or other data storage devices. Memory 158 can be fixed within the scanning system 100 or it can be removable. In the embodiment of FIG. 5, memory 158 is shown adjacent the processor 150. Data, such as control programs, digital images and metadata, can also be stored in remote memory. The scanning system 100 can use a communication system 160 for communicating, for example, an optical, radio frequency circuit having a transducer as well as appropriate signal processing circuitry to convert image and other data into a form that can be conveyed to a remote device. The communication system 160 can also be used to receive a digital image and other information from a host computer or network.

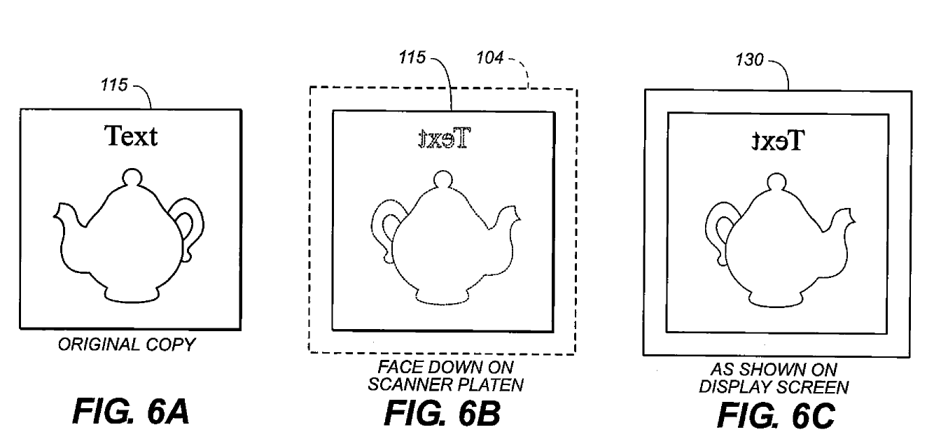

FIG. 6a shows the item 115 as it would “normally appear” to a user or as it would be seen by an image capture module 124 looking up from the underside of the platen 104 with the item 115 placed face-down prior to the copying process. FIG. 6b shows the orientation of item 115 as it has been placed face-down on platen 104. With the item 115, in this face-down position, the actual image 118 would not be visible, as shown in FIG. 6a, since the user would be looking at the backside of the media containing item 115 in the cover was open. FIG. 6c represents the processed image of item 115, as it has been inverted left-to-right and is now displayed to the user on display 130 of the system 100, including a border view of the “previewed” image. Note that the border could frame the item, a portion of the item or the whole platen depending on the user commands. In order to obtain the correct inversion of image 118 it is necessary to use the appropriate software in the processor.

This is especially critical when enlarging or reducing the image as well as in duplex mode or any manual adaptations performed by the user that changes the location of the item relative to the capture unit(s), This system can communicate to the user what the expected output would be if a full scan were initiated with the object in that position as shown in FIG. 6b. Once the user is satisfied that all the desired material is inside the border a high-resolution scan may then be initiated. In one example when the user has moved the physical image around on the platen to achieve the desired composition, the user may change the displayed border to whatever size the printer can output (4×6, 8.5×11, 8.5×14 etc). Similarly the user can choose the border to be displayed in a portrait or landscape orientation. It is also possible in some instances to obtain similar results by manipulating the border displayed on the LCD device itself such as grabbing the border by means of a touch screen and positioning it on the previewed image instead of moving the physical material that is to be scanned.

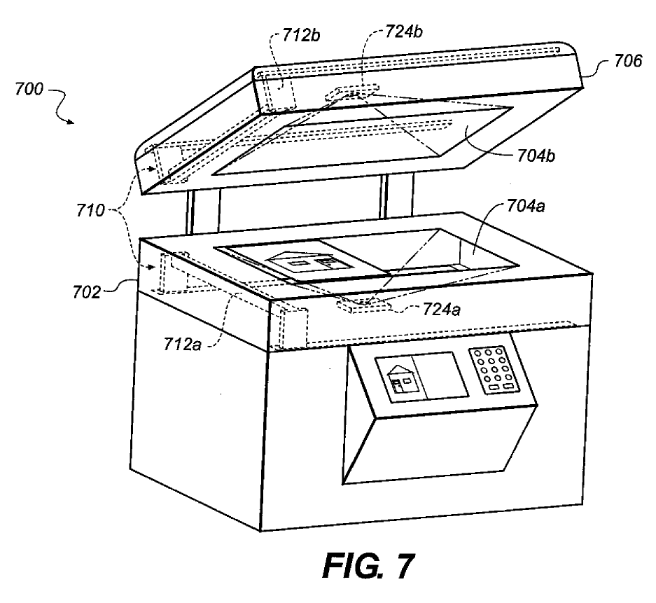

In one embodiment shown in FIG. 7, the scanning system 700 includes a body 702 and an upper housing 706 that are in communication, shown here together to enable both wide and thin articles to be scanned and copied. The scanning system 700 includes one or more scanning modules 710 and a transparent platen 704a,b that together define the image capture area. The upper housing 706 is shown in a pivoted and raised position such to allow the manual loading of items to be scanned. The one or more scanning modules 710 shown in this embodiment include both a linear imager 712a,b and an image capture module 724a,b that are contained both in the body 702 and in the upper housing 706.

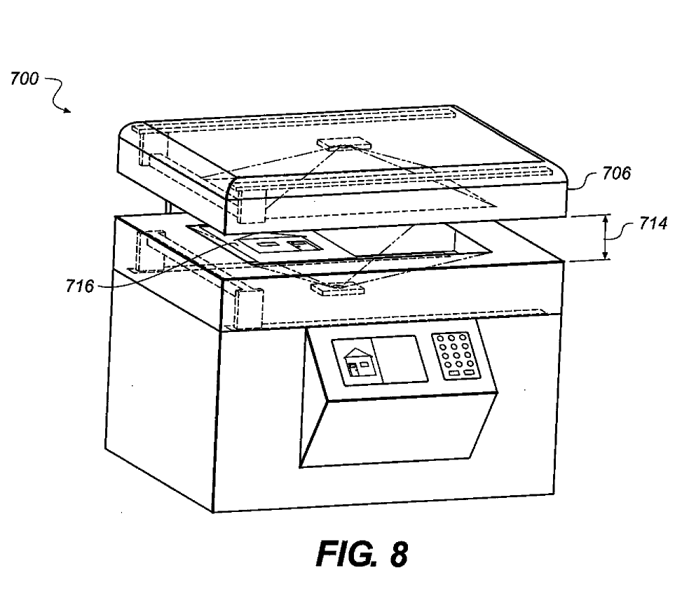

The scanning system 700 also includes one or more printing engines disposed in the body relative to at least one of the media transports similar to those described in FIG. 4 as transports 170. The one or more image capture modules are disposed in the body facing respective portions of the one or more media transports. The first set of linear imager 712a and an image capture module 724a are shown below the platen in this embodiment. The second linear imager 712b and an image capture module 724b are shown above the platen and are especially useful in this embodiment for displaying as real time display of the items that are to be duplex copied. These are also especially useful when coping large objects or objects that have a relief and thus would be difficult to view accurately with only a planar viewing subsystem. Real time viewing with high resolution is critical in the relief and larger, thicker items and the one or more capture modules described will be able to give the user an accurate view of all aspects and both sides of such objects. This embodiment is also useful for uniquely sized and shaped items and allows accurate real time viewing as discussed above. Any delicate item, such as antique books and 3-dimensional delicate items that can withstand only limited applied pressure would be able to be observed and thus protected using this method. It is possible to even do “non-contact” copying by positioning the upper housing 706 above the item 115, similar to the position shown in FIG. 8 but stopping the lid before it touches the item since real-time viewing is possible in this system.

FIG. 8 shows scanning module 700 with the upper housing 706 in a second position that is parallel to body 702. The area 710 in between body 702 and upper housing 706 is such that document 716 is accessible to the user for manual repositioning.

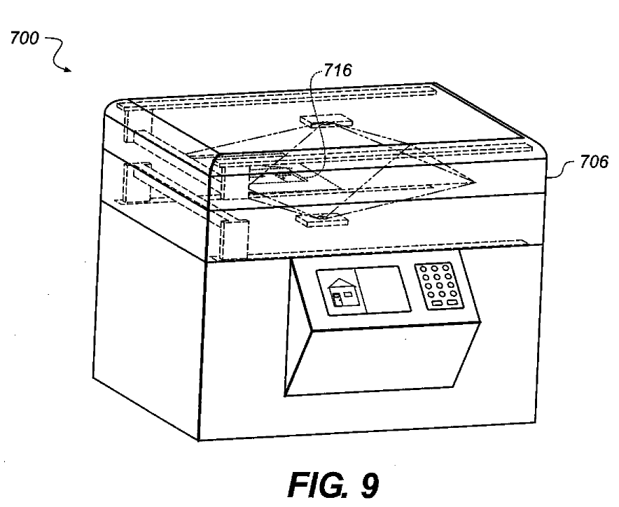

FIG. 9 shows scanning module 700 with the upper housing 706 lowered down to contain document 716 during the scanning operation.

### Operation

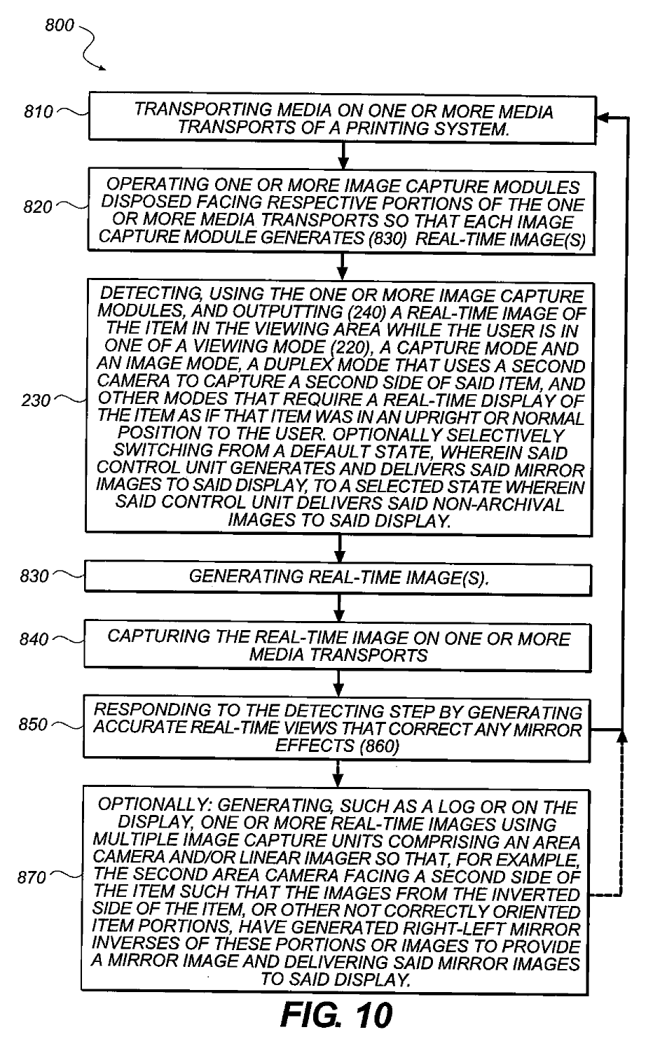

The display system shown in FIG. 10 is used when an item is being scanned would be applicable to any problem that can be aided by a real-time visual inspection and/or information such as is supplied by one or more image viewers. The method 800 includes the steps of the steps of transporting 810 media on one or more media transports of a printing system, during the transporting operating 820 one or more image capture modules disposed facing respective portions of the one or more media transports, each the image capture module generating 830 real-time image(s). Then capturing 840 the real-time image on one or more media transports and responding 850 to the detecting using the one or more image capture modules and by generating accurate real-time views that correct any mirror effects 860 and optionally generating a log 870 including one of more real-time images.

The method further includes correcting an image so that it is in its normal orientation as usually viewed by the user. For example by correcting for mirror inversions as shown in FIG. 10, so that the user can move the upside-down item and observe in real time the item as if it were right side up in front of the user. This eliminates the painful process of trying to move the item in the correct direction to enable accurate copied. This is especially useful when a portion of the item is to be copied a, enlarged or reduces in size. It is clear that this method would also be applicable to other areas of operations that have problems detectable by visual inspections that an image viewer could make but an operator would not be able to correctly observe in real-time without the aid of the image corrections as described herein. Other corrections are possible in a similar manner by using one or more of the capture devices shown in FIG. 5. This is also extendible to any duplex situation since this embodiment has a second pair of capture devices as discussed above.

A user of scanner module in the manual configuration manually positions upper scanner module at an edge of an area of image bearing medium to be scanned, and manually advances the upper scanner module across the area to be scanned along a first path. Where the area to be scanned is wider than the maximum scanner width, the upper scanner module can be returned to a start position and manually scanned along other scan paths of the medium until all portions of image bearing medium have been scanned. This can be done, for example, to enable scanning of oversized images or to allow scanning of oversized images, or to allow scanning of a scanning area that incorporates the entire image bearing medium such as to capture an image of an entire scrapbook page. In this example, the user of upper scanner module manually guides the upper scanner module over the wider media in a series of overlapping sections, which will be digitally “stitched” by the microprocessor. In this way upper scanner module can be dragged over image bearing medium by the user and feedback from the un-powered drive motor can be used to determine the scanner position and rate of movement. Alternatively, scanner module can be used to obtain images of only a portion of image bearing mediums.

The method shown in FIG. 10 for real-time viewing of a scanned image includes capturing one or more images in a capture zone defined by a border, which could be the outer limits of the platen or other, and generating right-left mirror inverses of each of said non-archival images to provide mirror images; and delivering said mirror images to a display. The system can use a mirror inverter to generate right-left mirror inverses of each of said non-archival images to provide a mirror image.

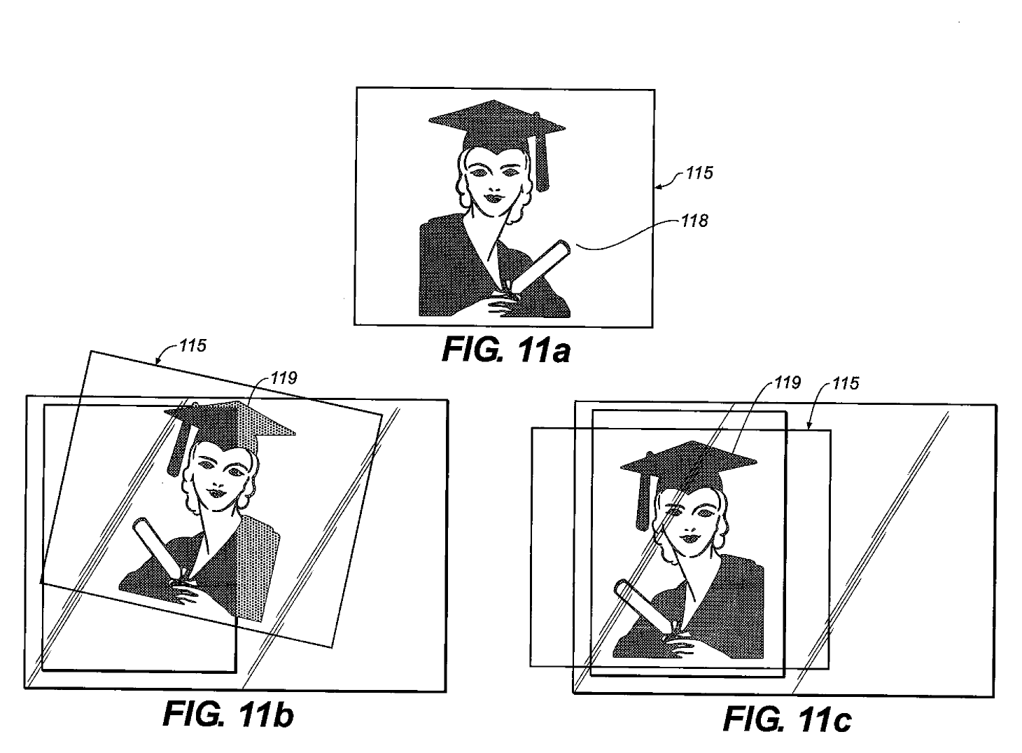

With the configuration previously described in FIG. 4, the image capture module 124 discussed above in conjunction to the embodiment described in FIG. 7, resides under platen 104 and faces up toward the image 118. Because of this specific camera-platen spatial and operational relationship a normal display of item 115 would be generated and viewed in real-time on display 130 as shown in FIG. 11a. Consequently when the user moves the item 115 in a direction from left to right the motion shown on display 130 will move in a reverse direction, right to left. This perceived reversed action and reaction presents the need for the user to learn to reverse their normal way of thinking to manipulate the item 115 while it is on the platen 104 which is difficult for some, and impossible for others, to accomplish and is further complicated by other adjustments, such as image size changes or margin adaptations, such as used for book binding.

The method shown in FIG. 11 demonstrates the left-to-right inversion of the image 118. FIG. 11a shows item 115 in a normal user viewing position. By processing the image 118 to display a version that is a left to right mirrored image 119 as shown in FIGS. 11b, 11c the display of the mirrored image 119, now shown on display 130 will now imitate the motion of the user positioning. Thus moving item 115 to the left while it is sitting face-down on platen 104 will now show a similarly leftward motion.

The invention has been described in detail with particular reference to certain preferred embodiments thereof, but it will be understood that variations and modifications can be effected within the spirit and scope of the invention.

### PARTS LIST

10 sheet-fed scanner
20 platen scanners
30 scanner
100 scanning system
102 body
104 platen
106 lid
108 image viewing system
110 scanning module/scanning unit
111 non-archival image
112 image forming subsystem
114 image capture zone
115 items (scan articles)
110 document
118 image
119 mirror image
120 printer engine/printer module/printer
124 image capture module
125 linear imager/linear imaging device
126 light source
130 display/display screen
140 controller
150 processor
152 housing
156 user input system
158 memory
160 communication system
170 transports
700 scanning system
702 body
704 platen
706 upper housing
710 scanning module/scanning unit
712 image forming subsystem
716 document
724 image capture module

1. A scanning system for use in capturing a close-up image on an item the scanning system for comprising:
a body;
a platen mounted to said body, said platen defining a capture zone adjoining said platen external to said body;
an image capture unit mounted in said body facing said capture zone said image capture unit being operative to capture real time images of said capture zone;
a display in communication with said body; and
a control unit to generate real-time images of the item.

2. The system of claim 1 said image capture unit comprising an area camera.

3. The system of claim 2 said image capture unit further comprising a CCD.

4. The system of claim 2 said image capture unit further comprising a linear imager.

5. The system of claim 2 said image capture unit further comprising a second area camera facing a second side of the item.

6. The system of claim 2 said image capture unit further comprising multiple area cameras facing one or more items.

7. The system of claim 1, said display mounted on said body adjacent to said platen to face outward from said body

8. The system of claim 1 said control unit receiving said images from said image capture unit, generating right-left mirror inverses of each of said images to provide a mirror image and delivering said mirror images to said display.

9. The system of claim 1 wherein said platen and display together define a user station having convergent sight lines from each of said platen and said display.

10. The system of claim 9 wherein said display faces in a direction at an angle from 0 to 90 degrees to an imaginary plane perpendicular to an optical axis of said image capture unit.

11. The system of claim 1 wherein said control unit selectively captures an archival image of said capture zone and outputs said archival image without right-left mirror inversion.

12. The system of claim 1 further comprising one or more user controls mounted to said body adjacent said display, wherein said generating is independent of said user controls.

13. The system of claim 1 wherein said body includes a control panel having first and second adjoining faces, said platen is disposed in one of said faces and said display is mounted to another of said faces.

14. The system of claim 1 wherein said control unit is selectively switchable from a default state, wherein said control unit generates and delivers said mirror images to said display, to a selected state wherein said control unit delivers said non-archival images to said display.

15. A method for real-time viewing a scanned image, the method comprising the steps of:
capturing one or more real time images of an item in a capture zone defined by a border relative to the platen and the capture unit of the scanner;
generating right-left mirror inverses of each of said images to provide mirror images; and
delivering said mirror images to said display.

16. The method of claim 15 said image capture unit comprising an area camera.

17. The method of claim 15 said image capture unit further comprising a second area camera facing a second side of the item.

18. The method of claim 1 further comprising receiving said images from said image capture unit before generating right-left mirror inverses of each of said images to provide a mirror image and delivering said mirror images to said display.

19. The method of claim 15 further comprising selectively switching from a default state, wherein said control unit generates and delivers said mirror images to said display, to a selected state wherein said control unit delivers said non-archival images to said display.

20. The method of claim 15 further comprising a capture mode and an image mode.

21. The method of claim 15 further comprising a duplex mode that uses a second camera to capture a second side of said item.

22. The method of claim 15 further comprising a non-contact node.
